(19) United States
(12) Patent Application Publication
(10) Pub. No.: US 2015/0332282 A1
(43) Pub. Date: Nov. 19, 2015

(54) UNIT-BASED LICENSING FOR COLLAGE CONTENT ACCESS

(71) Applicant: Altair Engineering, Inc., Troy, MI (US)

(72) Inventors: Massimo Fariello, Turin (IT); Stephanie Scapa, Menlo Park, MI (US)

(21) Appl. No.: 14/710,001

(22) Filed: May 12, 2015

Related U.S. Application Data
(60) Provisional application No. 61/994,485, filed on May 16, 2014.

(51) Int. Cl. G06Q 30/00; G06Q 50/20

(52) U.S. Cl. CPC G06Q 30/018; G06Q 50/20

(57) ABSTRACT

Unit-based licensing for collage content access may include receiving a content access request, which may indicate a customer account, collage information, and content. Unit-based licensing for collage content access may include identifying a cardinality of assigned units for the content, determining an adjusted cardinality of assigned units by adjusting the cardinality of assigned units based on the collage information, identifying a cardinality of available units allocated to the customer account, and determining whether the adjusted cardinality of the assigned units is within the cardinality of the available units. Unit-based licensing for collage content access may include outputting a response indicating that the request is granted on a condition that the adjusted cardinality of assigned units is within the cardinality of the available units and outputting a response indicating that the request is denied on a condition that the adjusted cardinality of assigned units exceeds the cardinality of the available units.

### CROSS-REFERENCE TO RELATED APPLICATIONS

This application claims priority to U.S. Provisional Patent Application No. 61/994,485, filed on May 16, 2014, which is incorporated by reference in its entirety herein.

### TECHNICAL FIELD

The present disclosure relates to systems and methods of licensing access to digital content.

### BACKGROUND OF THE DISCLOSURE

Digital content such as computer software products, video games, music, and any other media capable of being embodied in digital format may be sold or licensed to an end user customer. For example, the right to copy, access, or execute the digital content may be licensed to a user and a provider or vendor may retain ownership of the rights to the content. Content, such as digital content, or live-performance content may be presented at an event, such as a concert, a gallery display, a sporting event, or any multiple access presentation of content. Accordingly, it may be desirable to provide unit-based licensing for collage content access.

### SUMMARY OF THE DISCLOSURE

Disclosed herein are aspects, features, elements, implementations, and embodiments of unit-based licensing for collage content access.

In an embodiment, a method of unit-based licensing for collage content access is disclosed. Unit-based licensing for collage content access may include receiving a content access request, the content access request indicating a customer account, collage information, and content. Unit-based licensing for collage content access may include identifying a cardinality of assigned units for the content, determining an adjusted cardinality of assigned units by adjusting the cardinality of assigned units based on the collage information, identifying a cardinality of available units allocated to the customer account, and determining, by a processor, whether the adjusted cardinality of the assigned units is within the cardinality of the available units. Unit-based licensing for collage content access may include outputting a response indicating that the request is granted on a condition that the adjusted cardinality of assigned units is within the cardinality of the available units. Unit-based licensing for collage content access may include outputting a response indicating that the request is denied on a condition that the adjusted cardinality of assigned units exceeds the cardinality of the available units.

In another embodiment, a method of unit-based licensing for collage content access is disclosed. Unit-based licensing for collage content access may include receiving a content access request, the content access request indicating a customer account, collage information, and a plurality of digital content objects, wherein the collage information includes at least one of amount of use information, context of use information, or synchronization information. Unit-based licensing for collage content access may include identifying a cardinality of assigned units for the content, determining an adjusted cardinality of assigned units by adjusting the cardinality of assigned units based on the collage information, identifying a cardinality of available units allocated to the customer account, and determining, by a processor, whether the adjusted cardinality of the assigned units is within the cardinality of the available units. Unit-based licensing for collage content access may include outputting a response indicating that the request is granted on a condition that the adjusted cardinality of assigned units is within the cardinality of the available units. Unit-based licensing for collage content access may include outputting a response indicating that the request is denied on a condition that the adjusted cardinality of assigned units exceeds the cardinality of the available units.

In another embodiment, a method of collage content access using unit-based licensing is disclosed. Collage content access using unit-based licensing may include generating a content access request, the content access request identifying a customer account, collage information, and content. Collage content access using unit-based licensing may include transmitting the content access request, and in response to transmitting the content access request, receiving a content access response. Collage content access using unit-based licensing may include presenting a collage including the content on a condition that the content access response indicates that the content access request is granted.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The description herein makes reference to the accompanying drawings wherein like reference numerals refer to like parts throughout the several views, and wherein:

FIG. 1 is a diagram of an example of a communication system for unit-based licensing for collage content access in accordance with embodiments of this disclosure;

FIG. 2 is a flow diagram of an example of unit-based licensing for content access in accordance with embodiments of this disclosure; and

FIG. 3 is a flow diagram of an example of content access using unit-based licensing in accordance with embodiments of this disclosure.

### DETAILED DESCRIPTION

A creator or owner of content, such as digital content, may control access to the content by licensing the content to end users. For example, licensing may include controlling the right to access content, which may include controlling the right to display, perform, distribute, or reproduce the content. Unit-based licensing may include licensing that controls access to content by allocating licensing units to a customer account, such that one or more licensing units may be redeemed or charged to access one or more events or digital content objects. For example, in some embodiments, a content provider may redeem licensing units and provide content in response to a request for access by a customer.

In some embodiments, a customer may include content in a collage, patchwork, or other combination of content. For example, a content collage may include a static or dynamic combination or arrangement of content and may be displayed publically, such as in an art exhibit or at an event. Unit-based licensing for collage content access may include controlling access to content included in a collage by redeeming licensing units allocated to the customer in exchange for the content included in the collage. In some embodiments, a collage may be presented on a digital platform, such as on a website via the Internet. In some embodiments, a collage may be publically accessible or privately accessible. For example, a collage may be presented via a website that is publically accessible or a web site that accessible by a designated user or group of users. In some embodiments, a collage may be accessible by a customer.

The aspects, features, elements, and embodiments of methods, procedures, or algorithms disclosed herein, or any part or parts thereof, may be implemented in a computer program, software, or firmware incorporated in a non-transitory computer-readable storage medium for execution by a computer or processor, such as a special purpose computer or processor, and may be implemented as a computer program product, such as a computer program product accessible from a tangible computer-usable or computer-readable medium.

As used herein, the terminology “computer” or “device” includes any unit, or combination of units, capable of performing any method, or any portion or portions thereof, disclosed herein. Devices may further include mobile devices that may include user equipment, a wireless transmit/receive unit, a mobile station, a fixed or mobile subscriber unit, a pager, a cellular telephone, a personal digital assistant (PDA), a computer, or any other type of user device capable of operating in a mobile environment.

As used herein, the terminology “processor” includes a single processor or multiple processors, such as one or more special purpose processors, one or more digital signal processors, one or more microprocessors, one or more controllers, one or more microcontrollers, one or more Application Specific Integrated Circuits (ASICs), one or more Application Specific Standard Products (ASSPs); one or more Field Programmable Gate Arrays (FPGAs) circuits, any other type or combination of integrated circuits (ICs), one or more state machines, or any combination thereof.

As used herein, the terminology “memory” includes any computer-usable or computer-readable medium or device that can, for example, tangibly contain, store, communicate, or transport any signal or information for use by or in connection with any processor. Examples of computer-readable storage mediums may include one or more read only memories, one or more random access memories, one or more registers, one or more cache memories, one or more semiconductor memory devices, one or more magnetic media, such as internal hard disks and removable disks, one or more magneto-optical media, one or more optical media such as CD-ROM disks, and digital versatile disks (DVDs), or any combination thereof.

As used herein, the terminology “example”, “embodiment”, “implementation”, “aspect”, “feature”, or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terminology “digital content” may include computer software programs, video games, music, movies, videos, or any other media that may be embodied in digital form, and which may be accessed, downloaded, input, or otherwise transferred to a computer or processor. Digital content may include digital data or digital files that may be processed by external application programs or may be executed by external software, hardware, or both. As used herein, the terminology “content” may include live content or fixed content. Fixed content may include any content that may be presented from a tangible storage medium, such as digital content. Live content may include any content that may be accessed substantially concurrently with the creation or generation of the content, such as the presentation of a movie in a movie theater, a concert, a sporting event, or any other live event.

As used herein, the terminology “event” may include any presentation, distribution, or display of content capable of concurrent, or nearly concurrent, access by multiple users. For example, an event may include a physical presentation, such a presentation at a movie theater, concert hall, park, venue, museum, or restaurant, or a virtual presentation, such as a broadcast over the Internet or a television broadcast.

As used herein, the terminology “access” or “accessing” may include presenting, downloading, executing, streaming, or otherwise interacting, or enabling interaction, with a digital content object or event. In some embodiments, digital content objects may be executed, stored, or both, at a provider location. In some embodiments, digital content objects may be stored locally on a customer network or customer device and the digital content objects may be executed or run on the customer network or device.

In some embodiments, a node based license may indicate that content is accessible by a unique device, such as a computer, a unique account, such as an account associated with an individual user, or a combination of a unique device and a unique account. In some embodiments, a network based license may indicate that content is accessible by one or more devices within a specified network. For example, a defined number of devices within the network may concurrently access the content. In some embodiments, a license, including a node based license or a network based license, may be associated with a unique content object or event, or with a suite of related content objects and events.

As used herein, the terminology “assigned units”, “price”, “licensing price” or variations thereof, may include an assigned number of licensing units that may be exchanged or redeemed to access a particular event or digital content object. As used herein, the terminology “licensed units” or “allocated units” may refer to a total number of units provided to a customer or customer group. As used herein, the terminology “checked out units”, “redeemed units”, or “exchanged units” may refer to assigned units charged to a customer for events or digital content being accessed. “Available units” may refer to a difference between licensed units and checked out units. In some embodiments, licensing units may be temporarily or permanently exchanged for access. Temporarily exchanged licensing units may be returned to the pool of available units associated with the customer upon termination or completion of content access. Returned units may be included in the available units allocated to the customer and may be redeemed for access to other events or digital content.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

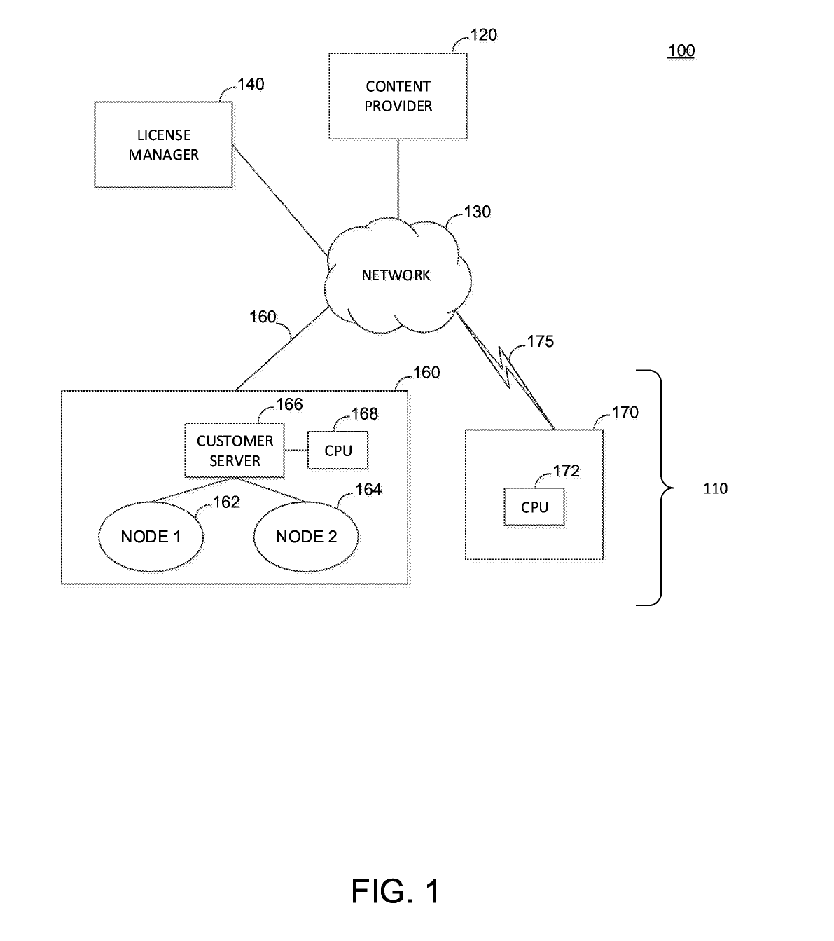

FIG. 1 is a diagram of an example of a communication system 100 for unit-based licensing for collage content access in accordance with embodiments of this disclosure. For simplicity, the communication system 100 shown in FIG. 1 includes a customer system 110, a provider 120, a network 130, and a license manager 140; however, other elements, such as multiple networks, access points, or communication mediums may be included in a communication system for unit-based licensing for collage content access.

In some embodiments, customer system 110 may be associated with an individual user or customer, and the user may access events or digital content using licensing units allocated to the user or to an account representing the user. In some embodiments, customer system 110 may comprise devices and networks through which a customer or user may access digital content from provider 120, or register for, or access, events. For example, as shown in FIG. 1, customer system 110 may include a customer network 160 and a customer device 170; however, any number of customer networks and customer devices may be used.

In some implementations, customer system 110 may be associated with a collection or group of customers, or members, and shared licensing units may be allocated to the group. For example, a group may include one or more families, a classroom of students, a small business, a social group, or any other organization capable of licensing events or digital content such that members of the group are capable of accessing the events or digital content.

In some embodiments, elements of the customer system 110, such as customer network 160 and customer device 170, may communicate with each other or with elements external to the customer system 110, such as the provider 120. For example, customer network 160 and customer device 170 may independently communicate through communication network 130.

In some embodiments, customer network 160 may include one or more individual nodes 162/164, a customer server 166, a host processor (CPU) 168, or any combination thereof. A node 162/164 may be a device, such as a computer, and may access digital content. For example, a node 162/164 may access digital content in response to user input. Although FIG. 1 includes a first node 162 and a second node 164 for simplicity, any number of nodes may be used. In some embodiments, a node 162/164 may be connected to a customer server 166 and may have a unique network address. In some embodiments, a node 162/164 may communicate with other nodes 162/164 within customer network 160. The customer server 166 may communicate with CPU 168. Although individual nodes 162/164 are depicted as being connected in a spoke configuration to the customer server 166, the individual nodes 162/164 may be connected in any other electronic computer network configuration. Although shown as separate units, in some embodiments, customer server 166 and CPU 168 may be combined into a single device.

In some embodiments, customer device 170 may be any device, such as a computer or mobile device, capable of accessing digital content. In some embodiments, a customer device 170 may include a processor, such as CPU 172.

In some embodiments, provider 120 may be a device or system configured to provide access to digital content to one or more licensed customers. For example, provider 120 may include an Internet Protocol (IP) network-based unit, such as a website service, that implements methods for controlling access to events or digital content. In some embodiments, provider 120 may provide customer system 110 access to digital content objects, which may be included in a suite of digital content. In some embodiments, provider 120 may be any system configured to control access to or registration for events by licensed customers. Although FIG. 1 shows the provider 120 as a single unit, the provider 120 may include any number of discrete units and any number of providers 120 may be used.

In some embodiments, the provider 120 may include an event provider (not shown separately) and may control access to or registration for one or more events. The event provider may be any system configured to receive a request to access or register for an event and output a response indicating whether access or registration is granted. In some embodiments, the request for access may include a request to register for the event, which may include receiving registration information. In some embodiments, the event provider may be the provider 120. In some embodiments, event provider may be separate from provider 120. Although shown as a single unit in FIG. 1, in some embodiments, the provider 120 may include a content provider as a first unit and the event provider as a second unit. For example, the content provider and the event provider may be independent units within a single physical device, or may be independent physical devices.

In some implementations, unit-based licensing for events and digital content may include communication between the customer system 110 and the provider 120 via the communication network 130. The communication network 130 may be a local area network (LAN), wide area network (WAN), virtual private network (VPN), a mobile or cellular telephone network, the Internet, or any other electronic communication medium. Although not explicitly shown in FIG. 1, each of the customer system 110, provider 120, and license manager 140 may communicate with communication network 130 through one or more Internet service providers (ISPs). In some embodiments, the customer network 160, the customer device 170, or both, may communicate with the network 130 via a wired connection 165 a wireless connection 175, or a combination of one or more wired or wireless connections.

In some embodiments, a license manager (LM) 140 may be included in the communication system 100. License manager 140 may control the access to events, digital content, or both, provided by provider 120. Although shown as a separate unit, in some embodiments, license manager 140 may be incorporated with provider 120, customer system 110, or both. In some embodiments, the license manager 140 may monitor content access for the customer system 110. For example, the license manager 140 may detect the termination or conclusion of access to content.

In some embodiments, license manager 140 may generate and maintain a log. The log may include a record of a number of available units that may be used by the customer system 110 at any given time. In some embodiments, the license manager 140 may update the log for each change of the available units for customer system 110. For example, the log may be updated to indicate a change in the available units in response to the accessing of events or digital content from provider 120, the termination of the access of events or digital content, or a change in pricing of events or digital content being accessed by the customer. In some embodiments, the log may be a file, or database, stored in a memory in communication with provider 120 or license manager 140.

Although not shown in FIG. 1, in some embodiments, communication system 100 may include a registration unit. In some embodiments, a registration unit may be a device, such as a computer. For example, the registration unit may be a kiosk physically located at an event location. In some embodiments, the registration unit may be configured to receive registration information. For example, the registration unit may include a user interface device, such as a keyboard or touchscreen, and may receive user input indicating registration information via the user input device. In some embodiments, the registration unit may communicate with a user device, such as customer device 170.

In some embodiments, unit-based licensing for collage content access may include controlling access to content in response to a request to access the event or digital content from a customer system.

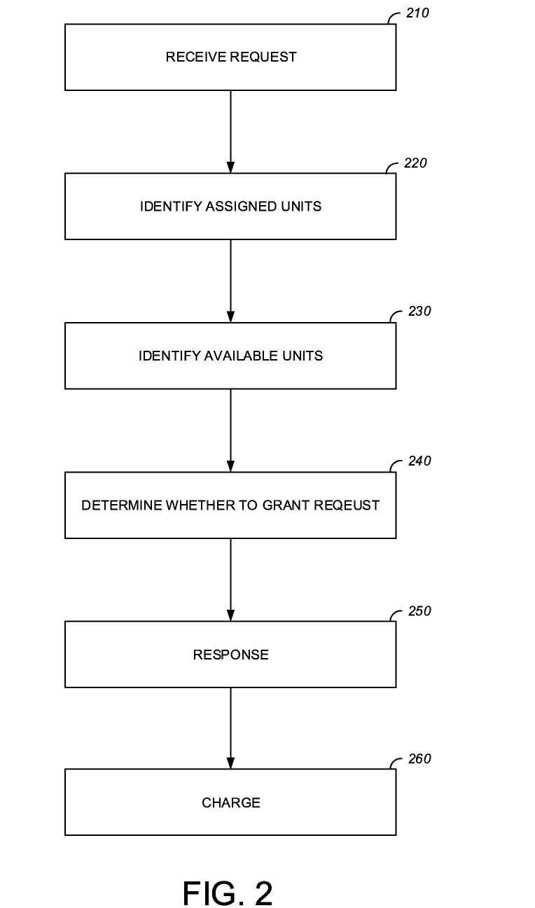

FIG. 2 is a flow diagram of an example of unit-based licensing for collage content access in accordance with embodiments of this disclosure. Unit-based licensing for collage content access may include temporarily or permanently exchanging licensing units for access to content in a collage. In some embodiments, unit-based licensing for collage content access may be implemented in a communication system, such as the communication system 100 shown in FIG. 1.

In some embodiments, unit-based licensing for collage content access may include receiving a request to access a digital content object at 210, identifying an amount of assigned units for the digital content object at 220, identifying an amount of available units 230, determining whether to grant the request at 240, responding to the request at 250, or a combination thereof.

In some embodiments, a request to access content may be received at 210. For example, a provider, such as the provider 120 shown in FIG. 1, may receive the request from a customer, such as the customer system 110 shown in FIG. 1, or an element thereof, which may be a customer device, such as the customer device 170 shown in FIG. 1. In some embodiments, the request may indicate a selected digital content object. In some embodiments, the request to access content may include information identifying the customer, such as account information associated with the customer system.

In some embodiments, the request may include collage information. For example, the collage information may indicate an amount of use for the digital content object, a context of use for the digital content object, or any other information relevant to unit-based licensing for event and digital content access. In some embodiments, one or more portions of the content indicated by the amount of use information may overlap temporally, spatially, or both.

In some embodiments, the amount of use information may indicate a portion or portions of the digital content object, such as a temporal portion, a spatial portion, or a combination thereof. For example, the digital content object may be a video and the amount of use information may indicate a start time and stop time relative to the digital content object indicating a request to include the portion of the video between the start time and the stop time in the collage, or the digital content object may be an image and the amount of use information may indicate a request to include a portion, such as an area or percentage, of the image in the collage.

In some embodiments, the amount of use information may include duration information. For example, the amount of use information may indicate a request to include the content in a collage for a period of time or duration.

In some embodiments, the amount of use information may include scale information. For example, the amount of use information may indicate a size, which may be a relative size, of the content as included in the collage, a sound level, loudness, volume, or strength, or a combination of size and volume.

In some embodiments, the amount of use information may include frequency information. For example, the content object may be temporal, such as audio or video content, and the amount of use information may indicate a request to include the content in the collage repeatedly or periodically at a particular frequency, a range of frequencies, or may indicate a count of the number of times the content object will be repeated in the collage during a period of time.

In some embodiments, the context of use information may indicate a request to access the content in a particular context. For example, the context information may indicate a request to access the content as part of an art exhibit or as part of a commercial display. In some embodiments, the context information may indicate a number, count, or cardinality, of content consumers, which may be an estimate or prediction. In some embodiments, the cardinality of consumers may correspond with a duration of use, which may be identified in the collage information. For example, the cardinality of consumers may correspond with a single presentation of the collage. In another example, the cardinality of consumers may indicate a cardinality of consumers per second, minute, hour, day, week, month, year, or any other duration. For example, the collage may be presented in a location frequently accessed by many people, and the cardinality of consumers may be large, such as 500,000 per day.

In some embodiments, the collage information may include synchronization information. For example, the synchronization information may indicate that a digital content object may be synchronized with a timeline or with other content. In an example, the digital content object may be an audio or video content object that may have an original playback speed or frame rate, and the synchronization information may indicate an adjustment to the playback speed or frame rate. For example, a first digital content object may include a video, and a portion of the video may be slowed down to synchronize with a beat of an audio content object.

In some embodiments, assigned license units for the selected digital content may be identified at 220. In some embodiments, the number of assigned units for an event or digital content object may remain constant or may vary over time. In some embodiments, a license manager, such as the license manager 140 shown in FIG. 1, may identify the assigned license units for the selected event or digital content. In some embodiments, the license manager may be independent of the provider, and the license manager may receive the request from the customer system via the network or via the provider. In some embodiments, determining the assigned license units for the selected digital content may include determining an adjusted number of licensing units based on the number of assigned licensing units for the selected digital content and the collage information.

In some embodiments, a number or cardinality of available units associated with the customer system may be determined at 230. The available units may indicate a number of licensing units that may be used by the customer system at a given time, such as at the time the request is received. For example, although not shown in FIG. 2, one or more licensing units may be allocated or licensed to the customer system, one or more of the allocated units may be temporarily or permanently exchanged or checked out for access to content, and the number of available units may indicate the difference between the number of allocated units and the number of checked out units.

In some embodiments, a collage may include multiple digital content objects, each digital content object may have an assigned number of units, and the assigned units for each digital content object in the collage may be combined or stacked to generate a number of assigned units associated with the collage. For example, a collage may include a first digital content object having five assigned units and a second digital content object having ten assigned units, and the number of assigned units for the collage may be 15.

In some embodiments, a collage may include multiple digital content objects, each digital content object may have an assigned number of units, and the assigned units for each digital content object in the collage may be averaged or leveled to generate a number of assigned units associated with the collage. In some embodiments, the number of assigned units associated with a collage may be leveled based on the digital content object included in the collage having the maximum number of assigned units relative to the other digital content objects included in the collage. For example, a collage may include a first digital content object having five assigned units and a second digital content object having ten assigned units, and the leveled number of assigned units for the collage may be ten.

In some embodiments, the number of assigned units for a collage may vary. In some embodiments, a collage may include multiple digital content objects, each digital content object may have an assigned number of units, and the assigned units for each digital content object in the collage may be leveled, stacked, or a combination thereof to generate a number of assigned units associated with the collage. For example, a collage may include a first digital content object having ten assigned units and a second digital content object having five assigned units. The first and second digital content objects may be concurrently displayed for a first portion of the collage, such as for first time period. A second portion of the collage, such as a second time period, may include presenting the second digital content object an omitting the first digital content object. In some embodiments, the number of assigned units for presenting a portion of the collage may be determined by stacking the number of assigned units for the digital content objects included in the portion. For example, the number of assigned units for presenting the first portion of the collage may be 15 and the number of assigned units for displaying the second portion of the collage may be five. In some embodiments, the number of assigned units for presenting a portion of the collage may be determined by leveling the number of assigned units for the digital content objects included in the portion. For example, the number of assigned units for presenting the first portion of the collage may be ten and the number of assigned units for displaying the second portion of the collage may be five. In some embodiments, transitioning from displaying the first portion to displaying the second portion may include updating the number of available units associated with the customer based on the difference in the number of assigned units for the first portion and the second portion.

In some embodiments, whether to grant access may be determined at 240. For example, determining whether to grant access at 240 may be based on the count of available units for the customer, the count of checked out units for the customer, the number of assigned units for the event or digital content, or a combination thereof. For example, determining whether to grant access at 240 may include determining whether the count of available units for the customer is equal to or greater than the number of assigned units for the event or digital content.

In some embodiments, determining whether to grant access at 240 may include determining the number of available licensing units allocated to the customer system to charge against the customer system for access to the selected content. In some embodiments, the provider or the licensing manager may determine the number of checked out units currently charged against the customer system, and may determine a number of licensing units to charge against the customer system based on a difference between the number of assigned units for the requested content and the number of currently checked out units for the customer. For example, the number of currently checked out units for the customer may be greater than the number of assigned units, the request may be granted and the number of units to charge against the customer system may be zero. In another example, the number of currently checked out units for the customer may be less than the number of assigned units, the request may be granted, and the number of units to charge against the customer system may be equal to the difference between the number of assigned units and the number of currently checked out units.

In some embodiments, a response may be output at 250. For example, the provider or licensing manager may generate a response indicating that the request for access is granted or denied and may transmit the response to the customer system. In some embodiments, the request for access may be denied. For example, the number of available units associated with the customer may be less than the number of assigned units for the requested event or digital content and the request may be denied. In some embodiments, the provider may reject the request and may prevent the customer system from accessing to the content. In some embodiments, the request for access may be granted. For example, the number of available units associated with the customer may be equal to or greater than the number of assigned units for the requested event or digital content and the request may be granted.

In some embodiments, a number of available licensing units allocated to the customer system may be charged to the customer system at 260. In some embodiments, the customer system may be charged in response to granting the request for access. In some embodiments, the customer system may be charged in response to receiving the content at the customer system from the provider. In some embodiments, the customer system may be charged in response to accessing the content by one or more customer devices or nodes in the customer system.

In some embodiments, charging the customer system may include recording the number of licensing units charged, updating the number available units associated with the customer system, or both. In some embodiments, the license manager or provider may record any change in charged units or available units in a log. In some embodiments, the number of available units for the customer system may be decreased in an amount equal to the number of assigned units for the event or digital content indicated in the request.

In some embodiments, charging the customer system at 260 may include receiving information indicating that a customer device or node is accessing the requested content. For example, the content may be accessed from the provider in response to outputting the response at 250.

In some embodiments, a collage may include content that is not owned by the provider, such as public domain content, customer owned content, third party owned content, or a combination thereof. For example, a first customer may create a collage, which may include a combination of a video object generated by the customer, such as a clip of a home movie, an image generated by the customer, audio owned by a third party, text from the public domain, and other graphical or layout elements generated by the customer. In some embodiments, the collage information may include a customer defined or third party defined number of assigned units for digital content not owned by provider. In some embodiments, another customer may access the collage and the number of assigned units for accessing the collage may be based on the number of assigned units for the digital content objects owned by provider, the number of assigned units for the digital content objects owned by the first customer, and the number of assigned units for the digital content objects owned by the third party. In some embodiments, a customer may be charged a number of assigned units for creating, or during the creation of, the collage.

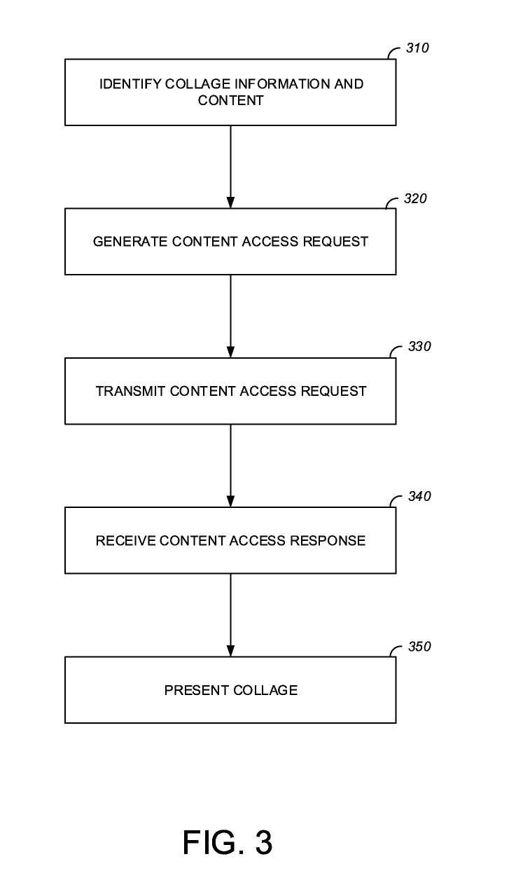

FIG. 3 is a flow diagram of an example of collage content access using unit-based licensing in accordance with embodiments of this disclosure. Collage content access using unit-based licensing may include temporarily or permanently exchanging licensing units for access to content in a collage. In some embodiments, collage content access using unit-based licensing may be implemented in a communication system, such as the communication system 100 shown in FIG. 1.

In some embodiments, collage content access using unit-based licensing may include identifying collage information and content at 310, generating a content access request at 320, transmitting the content access request at 330, receiving a content access response at 340, presenting a collage at 350, or a combination thereof.

In some embodiments, collage information and content may be identified at 310. In some embodiments, identifying the content at 310 may include identifying one or more digital content objects, such as one or more songs, one or more videos, one or more images, or any other type of digital content object. In some embodiments, identifying the collage information at 310 may include identifying amount of use information for the content, context of use information for the content, synchronization information for the content, or any other information relevant to unit-based licensing for event and digital content access.

In some embodiments, a content access request may be generated at 320. In some embodiments, generating the content access request at 320 may include identifying customer information, such as a customer account identifier, a user identifier associated with the customer account, a device identifier associated with the customer account, or a combination thereof. In some embodiments, the customer information, the collage information, content information, or a combination thereof may be included in the content access request.

In some embodiments, the content access request may be transmitted at 330. For example, a customer, such as the customer system 110 shown in FIG. 1, or an element thereof, which may be a customer device, such as the customer device 170 shown in FIG. 1, may generate the content access request at 320 and may transmit the content access request at 330 to a provider, such as the provider 120 shown in FIG. 1, a licensing manager, such as the license manager 140 shown in FIG. 1, or a combination thereof.

In some embodiments, a content access response may be received at 340. For example, in response to transmitting the customer access request at 330, a customer, such as the customer system 110 shown in FIG. 1, or an element thereof, which may be a customer device, such as the customer device 170 shown in FIG. 1, may receive a content access response at 340 from a provider, such as the provider 120 shown in FIG. 1, a licensing manager, such as the license manager 140 shown in FIG. 1, or a combination thereof.

In some embodiments, the collage may be presented at 350. For example, presenting the collage may include accessing or presenting the content identified at 310 as indicated in the collage information identified at 310.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method comprising:
receiving a content access request, the content access request indicating a customer account, collage information, and content;
identifying a cardinality of assigned units for the content;
determining an adjusted cardinality of assigned units by adjusting the cardinality of assigned units based on the collage information;
identifying a cardinality of available units allocated to the customer account;
determining, by a processor, whether the adjusted cardinality of the assigned units is within the cardinality of the available units;
outputting a response indicating that the request is granted on a condition that the adjusted cardinality of assigned units is within the cardinality of the available units; and
outputting a response indicating that the request is denied on a condition that the adjusted cardinality of assigned units exceeds the cardinality of the available units.

2. The method of claim 1, wherein receiving the content access request includes receiving the content access request from a device associated with the customer account.

3. The method of claim 1, wherein the content access request includes a plurality of digital content object identifiers, wherein each digital content object identifier from the plurality of digital content object identifiers identifies a respective digital content object.

4. The method of claim 1, wherein the collage information indicates an amount of use for the content.

5. The method of claim 4, wherein the amount of use for the content identifies a portion of the content.

6. The method of claim 4, wherein the amount of use for the content identifies a plurality of portions of the content.

7. The method of claim 6, wherein a first portion from the plurality of portions of the content may overlap a second portion from the plurality of portions of the content.

8. The method of claim 4, wherein the amount of use for the content identifies a temporal portion of the content.

9. The method of claim 4, wherein the amount of use for the content identifies a spatial portion of the content.

10. The method of claim 4, wherein the amount of use for the content identifies a duration of use for the content.

11. The method of claim 4, wherein the amount of use for the content identifies a scale of use for the content.

12. The method of claim 4, wherein the amount of use for the content identifies a frequency of use for the content.

13. The method of claim 1, wherein the collage information indicates a context of use for the content.

14. The method of claim 1, wherein the context of use for the content indicates a cardinality of consumers.

15. The method of claim 1, wherein the collage information includes synchronization information.

16. A method comprising:
receiving a content access request, the content access request indicating a customer account, collage information, and a plurality of digital content objects, wherein the collage information includes at least one of amount of use information, context of use information, or synchronization information;
identifying a cardinality of assigned units for the content;
determining an adjusted cardinality of assigned units by adjusting the cardinality of assigned units based on the collage information;
identifying a cardinality of available units allocated to the customer account;
determining, by a processor, whether the adjusted cardinality of the assigned units is within the cardinality of the available units;
outputting a response indicating that the request is granted on a condition that the adjusted cardinality of assigned units is within the cardinality of the available units; and
outputting a response indicating that the request is denied on a condition that the adjusted cardinality of assigned units exceeds the cardinality of the available units.

17. The method of claim 16, wherein receiving the content access request includes receiving the content access request from a device associated with the customer account.

18. The method of claim 16, wherein the amount of use information includes at least one of:
information that identifies a temporal portion of the content;
information that identifies a spatial portion of the content;
information that identifies a duration of use for the content;
information that identifies a scale of use for the content; or
information that identifies a frequency of use for the content.

19. The method of claim 16, wherein the context of use information indicates a cardinality of consumers.

20. A method comprising:
generating a content access request, the content access request identifying a customer account, collage information, and content;
transmitting the content access request;
in response to transmitting the content access request, receiving a content access response; and
presenting a collage including the content on a condition that the content access response indicates that the content access request is granted.
